(19) United States
(12) Patent Application Publication
(10) Pub. No.: US 2006/0000811 A1
(43) Pub. Date: Jan. 5, 2006

(54) Diffractive optical element changer for versatile use in laser manufacturing

(75) Inventors: Daniel Hogan, Acton, MA (US); Xinbing Liu, Acton, MA (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/882,093

(22) Filed: Jun. 30, 2004

(51) Int. Cl. B23K 26/38; B23K 26/067

(52) U.S. Cl. 219/121.7; 219/121.77; 219/121.73

(57) ABSTRACT

A DOE array apparatus includes a plurality of different interchangeable DOEs for use with lasers in manufacturing for versatile tasks such as drilling holes or vias of various sizes and shapes and multiple ablation or material transformation patterns in a surface of an object. A method of using the apparatus in laser processing systems includes: determining a specification for the number of patterns and/or the number of layers to be patterned, designing the appropriate number of DOEs according to the product specification, assembling the DOEs into an array to be used in a laser processing system, ablating the layer on the object through laser processing, determining whether more patterns on the layer are to be processed, determining whether more layers are to be patterned, and changing and aligning the DOE for the next laser ablation or material transformation pattern to be processed.

### FIELD OF THE INVENTION

The present invention relates to a diffractive optical element (DOE) array apparatus and method of using the apparatus in laser processing. More specifically, the present invention relates to a way of interchanging DOEs for use with lasers in manufacturing for versatile tasks such as drilling holes or vias of various sizes and shapes and multiple ablation or material transformation patterns in a surface of an object

### BACKGROUND OF THE INVENTION

There is an ever-increasing demand for smaller and smaller electronic devices in today's high-tech marketplace. As a result, new and innovative fabrication techniques have become a focal point of many manufacturers. Many manufacturers have turned to laser processing as a means of fabrication, (e.g. for blowing fuses, via and hole drilling, ablation patterning, resistor trimming, material transformation such as curing monomers to polymers, changing refractive index, transmissivity or reflectivity and etc.). However, laser processing systems are very costly and can be inefficient. Manufacturers have sought parallel laser processing methods to increase throughput and to reduce cost. Therefore, there exists a need to use parallel laser processing to increase throughput and to reduce cost in the fabrication of electronic devices.

The diffractive optical element (DOE) is one method of employing parallel laser processing for electronic device fabrication. The DOE enables parallel processing by optically diffracting and directly controlling the optical phases. Therefore, a wide range of applications including, for example, multi-spot beam splitters or shapers, can be expected as a result of this preferred benefit. The beam splitting or shaping can be used for drilling holes or vias of various sizes and shapes and multiple ablation or material transformation patterns. Compared to conventional beam splitting methods such as partial mirrors or amplitude masks, the DOE is compact and capable of generating massively parallel processing patterns. Also, unlike an amplitude mask that generates a pattern by blocking most of the incident laser beam, the DOE is very efficient because it is non-absorbing.

A system and method of laser drilling is detailed in U.S. Patent Application 20030102291. The '291 patent application describes a method of parallel laser processing with a single DOE. However, the '291 patent application does not address the process of changing the DOE for additional ablation patterns, (e.g., for patterning multi-leveled circuit boards). For example, the '291 patent application and other current systems require that the DOE be changed either manually or robotically in the system. Changing the DOE using current conventional methods, even robotically, can be time-consuming and inefficient and therefore costly. Alternatively, multiple laser processing machines are used, with each machine using a single DOE for a single pattern, and work pieces transferred from machine to machine for multiple patterns to be processed. However, this alternative would be more costly. Therefore, there exists a need to streamline the DOE changing process in DOE laser processing systems for quicker fabrication of electronic devices. Also, in conventional laser processing systems that use DOEs, the hole or pattern density is limited by the density of the pattern on the DOE. With the miniaturization of electronic devices year by year, there further exists a need to pattern or drill holes or cause material transformations in an object with a greater density per square inch than one DOE can provide.

A method and apparatus for ablating a desired high-density pattern of vias in a surface of an object can be found in U.S. Pat. No. 6,256,121, entitled “Apparatus for ablating high-density array of vias or indentation in surface of object.” The '121 patent uses an X-axis and Y-axis automatic repeat positioning mechanism for redirecting a laser beam to a desired one holographic imaging lens in an array of holographic imaging lenses to make a via in a surface of the object. The repeat positioning then moves the laser beam to a different holographic imaging lens on the array for drilling another via in a different location on the object. The holographic imaging lenses may vary in application from one to another on the array to form different shapes on the surface of the object, thus, multiple shaped vias or holes can be formed in multiple locations. However, laser processing systems that use automatic repeat positioning mechanisms do not adequately employ parallel processing techniques and are therefore inefficient. Also, the addition of automatic repeat positioning mechanisms in a laser processing system adds undo complexity and cost to the manufacturer. Therefore there exists a need for a laser processing system that drills multiple holes or vias of various sizes and shapes, and further, drills multiple ablation patterns without adding complex, inefficient and costly automatic repeat positioning mechanisms for redirecting a laser beam.

It is therefore an object of this invention to use parallel laser processing to increase throughput and to reduce cost in the fabrication of electronic devices.

It is another object of this invention to streamline the DOE changing process in DOE laser processing systems for quicker fabrication of electronic devices.

It is yet another object of this invention to pattern or drill holes or cause material transformation in an object with a greater density per square inch than one DOE can provide.

It is yet another object of this invention to provide a laser processing system that drills holes or vias of various sizes and shapes and multiple ablation or material transformation patterns without using costly and inefficient automatic repeat positioning mechanisms for redirecting a laser beam.

### SUMMARY OF THE INVENTION

In accordance with the present invention, a DOE array apparatus includes a plurality of different interchangeable DOEs for use with lasers in manufacturing for versatile tasks such as drilling holes or vias of various sizes and shapes and multiple ablation or material transformation patterns on the surface or inside an object. A method of using the apparatus in laser processing systems includes: determining a specification for the number of patterns and/or the number of layers to be patterned, designing the appropriate number of DOEs according to the product specification, assembling the DOEs into an array to be used in a laser processing system, ablating the layer on the object through laser processing, determining whether more patterns on the layer are to be processed, determining whether more layers are to be patterned, and changing and aligning the DOE for the next laser ablation pattern to be processed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a subassembly of a laser processing system;

FIG. 2A illustrates a perspective view of DOE linear array 140, a preferred embodiment of a subassembly of a laser processing system;

FIG. 2B illustrates a top view of DOE linear array 140, a preferred embodiment of a subassembly of a laser processing system;

FIG. 2C illustrates a side view of DOE linear array 140, a preferred embodiment of a subassembly of a laser processing system;

FIG. 3A illustrates a top view of DOE rectangular array 300, an alternate preferred embodiment of a subassembly of a laser processing system;

FIG. 3B illustrates a side view of DOE rectangular array 300, an alternate preferred embodiment of a subassembly of a laser processing system;

FIG. 4A illustrates the top view of DOE wheel array 400, an alternate embodiment of a subassembly of a laser processing system;

FIG. 4B illustrates the cross-sectional view A-A′ of DOE wheel array 400, an alternate embodiment of a subassembly of a laser processing system; and

FIG. 5 illustrates a functional block diagram method of operating a subassembly of a laser processing system.

### DETAILED DESCRIPTION OF THE PREFERRED EMBODIMENTS

The following description of the preferred embodiment(s) is merely exemplary in nature and is in no way intended to limit the invention, its application, or uses.

The present invention relates to a diffractive optical element (DOE) array apparatus and method of using the apparatus in laser processing systems. More specifically, the present invention relates to a way of interchanging DOEs for use with lasers in manufacturing for versatile tasks such as drilling holes or vias of various sizes and shapes and multiple ablation or material transformation patterns in a surface of an object.

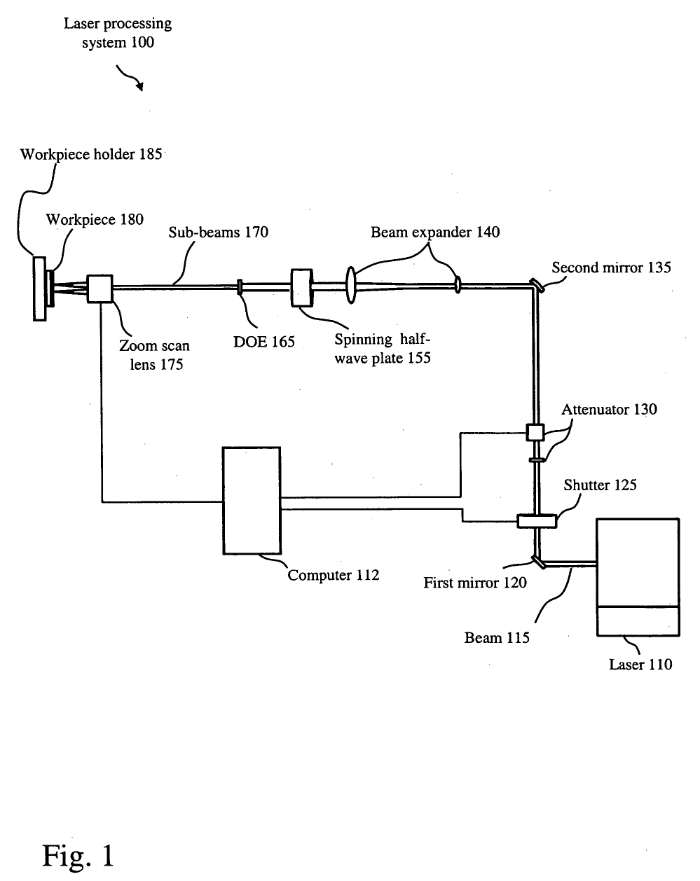

FIG. 1 illustrates a subassembly 100 of a laser processing system for drilling holes or vias of various sizes and shapes and multiple ablation or material transformation patterns in a surface of an object including a beam 110, a plurality of DOEs 130a, 130b, 130c, 130d, 130e, 130f, 130g, 130h and 130i (note that subassembly 100 may contain any number of DOEs and is not limited to nine), a linear DOE array 140, a DOE array holder 145, a plurality of sub-beams 150, a scan lens 160, and a workpiece 170 arranged as shown.

A pulsed or continuous wave (CW) laser (the laser must exhibit a sufficiently small bandwidth to avoid chromatic aberrations induced by the DOE) provides sufficient pulse energy or average power to ablate or transform material in workpiece 170. In one example, the laser may be a picosecond (ps) laser (bandwidth less than 0.1 nanometer) consisting of an oscillator and a regenerative amplifier, the oscillator output power equals 35 milliwatts (mW), the pulse width is approximately 15 ps, the regenerative amplifier output power is 1 Watt (W) at 1 killohertz (kHz) the energy per pulse is 1 millijoule (mJ), the power stability is 1.0% over 12 hours and the pointing stability is approximately 1%.

Linear DOE array 140 holds a plurality of DOEs 130a, 130b, 130c, 130d, 130e, 130f, 130g, 130h and 130i. A DOE is an optical element that acts as a beam splitter or shaper to allow a laser processing system to drill parallel holes or vias of various sizes and shapes and multiple ablation or material transformation patterns on a material on workpiece 170.

DOE array holder 145 is holds the DOE array 140 and is used to index the array through subassembly 100 in linear steps, one DOE per step.

Beam 110 is a laser beam, for example, from a ps laser. Sub-beams 150 are formed by beam 110 being transmitted through DOE 130a.

Scan lens 160 is an f-theta telecentric (scan) lens. Scan lens 160 determines the spot size of sub-beams 150 upon workpiece 170. The beam size that enters scan lens 160 must be less than or equal to the pupil size of scan lens 160. Telecentricity is required to keep the incident angle between sub-beams 140 and workpiece 170 perpendicular, which is necessary to drill parallel holes in workpiece 170. In an alternate embodiment, a non-telecentric lens is used to drill angled holes, if parallel holes in the work piece are not required.

Workpiece 170 is the target for subassembly 100. In one example, workpiece 170 is a stainless steel inkjet nozzle foil; however, the present invention may be generalized to a variety of workpiece materials, such as polymers, semiconductor metals, or ceramics. In alternate embodiments, subassembly 100 can drill holes or cause material transformations of a wide variety of shapes and tapers in workpiece 170.

A brief description of the operation of subassembly 100 is provided below. In alternate embodiments, changes in the elements of subassembly 100 may be required. The present invention is not limited to the current selection and arrangement of elements in subassembly 100.

In operation, beam 110 is emitted from a laser source; for example, a ps laser (not shown) propagates along the optical path identified in FIG. 1. DOE 130a splits beam 110 into sub-beams 150. Sub-beams 150 exit DOE 130a and propagate along the optical path, where they are incident upon scan lens 160. Scan lens 160 determines the spot size of sub-beams 150 upon workpiece 170. Sub-beams 150 exit scan lens 160 and propagate along the optical path, where they are focused onto workpiece 170. Sub-beams 150 ablate or transform workpiece 170. Alternate holes, vias or patterns may be ablated or transformed with a different DOE 130b, c, d, e, f, g, h, or i on the linear DOE array 140.

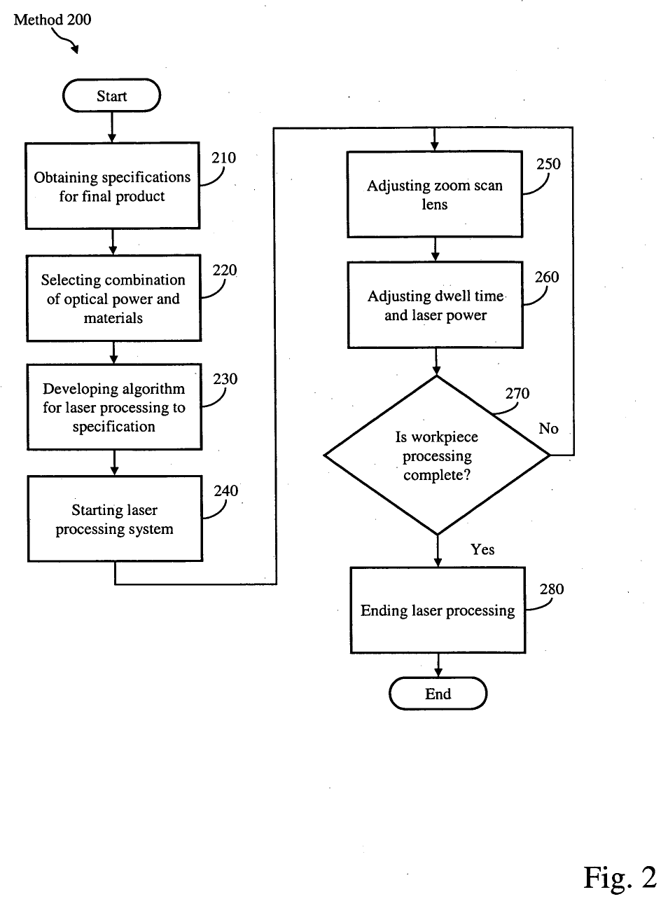

FIGS. 2A, 2B and 2C illustrate DOE linear array 140 including DOE base 210 holding a plurality of DOEs 130a, 130b, 130c, 130d, 130e, 130f, 130g, 130h and 130i and DOE array holder 145 holding DOE array 140.

FIG. 2A illustrates a perspective view of DOE linear array 140. FIG. 2B illustrates a top view of DOE linear array 140. FIG. 2C illustrates a side view of DOE linear array 140.

DOE linear array 140 is one of the preferred array embodiments of subassembly 100. There may be any number of DOEs 130 held on DOE base 210 according to the product specifications. In one example the DOE base 210 is an aluminum (Al) plate with openings. The openings are counter-bored so the clear aperture is smaller than the size of the DOE. The DOEs are attached to the DOE base 210 by mechanical means or by an adhesive. The DOE array holder 145 holds DOE base 210 and is used to index the array through subassembly 100 in linear steps, one DOE per step. DOE 130a then 130b then 130c and so forth are sequenced through subassembly 100 one at a time in the X axis direction by indexing or mechanical stage mechanism as is in common use in optical assemblies. DOEs are often an etching on a glass substrate or alternatively could be a spun coat resist that has been made using a laser beam writer. DOEs 130a, 130b, 130c, 130d, 130e, 130f, 130g, 130h and 130i may have separate etchings for ablation or material transformation. However, in some cases it may be preferable to duplicate DOEs in different locations on the subassembly in order to reduce changeover time when swapping patterns.

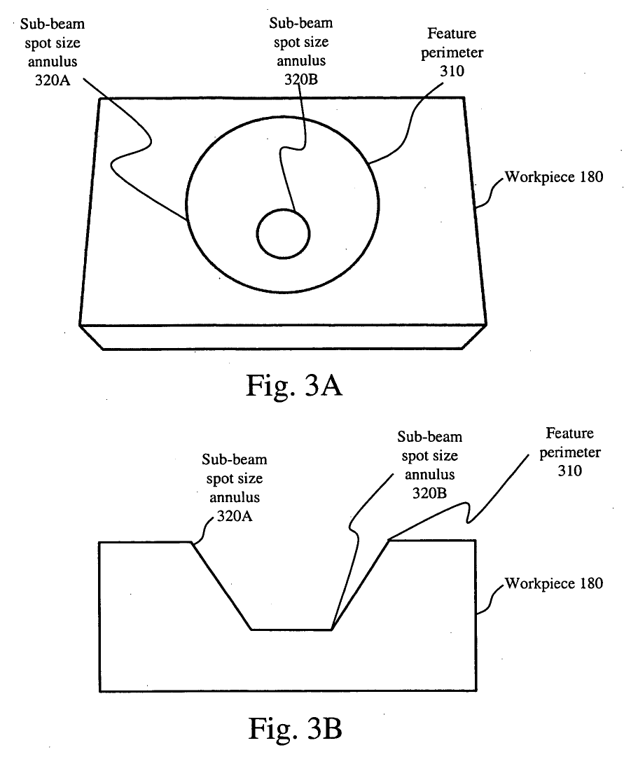

FIGS. 3A and 3B illustrate DOE rectangular array 300 including DOE base 310 holding a plurality of DOEs 130a, 130b, 130c, 130d, 130e, 130f, 130g, 130h and 130i and DOE array holder 345 holding DOE base 310. DOE square array 300 is an alternate embodiment of subassembly 100 to replace DOE linear array 140. DOE rectangular array 300 has equal preference as an embodiment to that of DOE rectangular array 140. However, the two dimensional rectangular array 300 will require different translation than the one dimensional DOE linear array 140 when the DOEs are sequenced through subassembly 100.

FIG. 3A illustrates a top view of DOE rectangular array 300. FIG. 3B illustrates a side view of DOE rectangular array 300.

There may be any number of DOEs 130 held on DOE base 310 according to the product specifications. In one example the DOE base 310 is an aluminum (Al) plate with openings. The openings are counter-bored so the clear aperture is smaller than the size of the DOE. The DOEs are attached to the DOE base 310 by mechanical means or by an adhesive. The DOE array holder 345 holds DOE base 310 and is used to index the array through subassembly 100 in steps, one DOE per step. DOE 130a then 130b then 130c and so forth are sequenced through subassembly 100 one at a time in the X and Y axis directions by indexing or mechanical stage mechanism as is in common use in optical assemblies. DOEs are often an etching on a glass substrate or alternatively could be a spun coat resist that has been made using a laser beam writer. DOEs 130a, 130b, 130c, 130d, 130e, 130f, 130g, 130h and 130i all have separate etchings for ablation or material transformation.

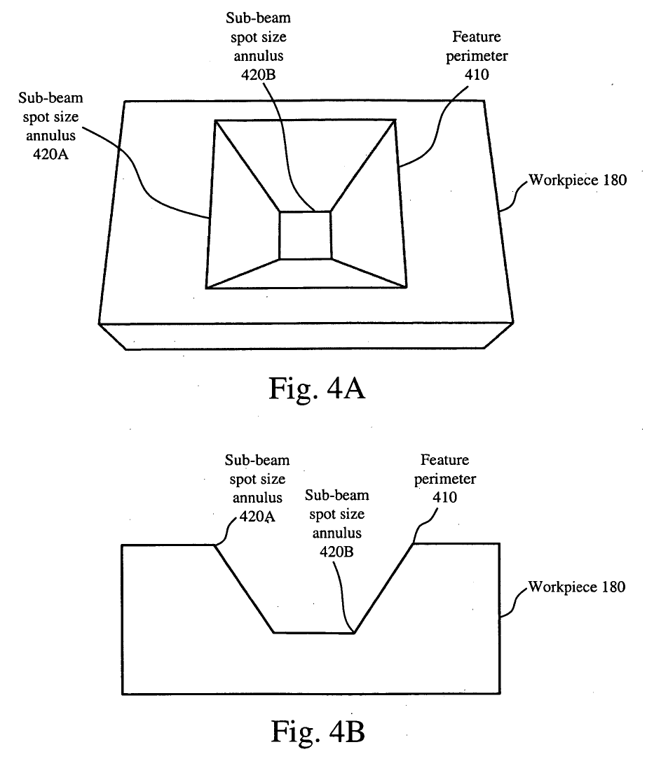

FIG. 4A and FIG. 4B illustrate DOE wheel array 400 including DOE base 410 holding a plurality of DOEs 130a, 130b, 130c, 130d, 130e, 130f, 130g, 130h and 130i. DOE wheel array 300 is an alternate embodiment of subassembly 100 to replace DOE rectangular array 140. There may be any number of DOEs 130 held on DOE base 410 according to the product specifications. In one example the DOE base 410 is an aluminum (Al) plate with openings. The openings are counter-bored so the clear aperture is smaller than the size of the DOE. The DOEs are attached to the DOE base 410 by mechanical means or by an adhesive. The DOE array holder 445 holds DOE base 410 and is used to index the array through subassembly 100 in steps, one DOE per step. DOE 130a then 130b then 130c and so forth are sequenced through subassembly 100 one at a time in theta (θ) rotational axis direction by indexing or mechanical stage mechanism as is in common use in optical assemblies. DOEs are often an etching on a glass substrate or alternatively could be a spun coat resist that has been made using a laser beam writer. DOEs 130a, 130b, 130c, 130d, 130e, 130f, 130g, 130h and 130i all have separate etchings for ablation or material transformation.

FIG. 4A illustrates the top view of DOE wheel array 400. FIG. 4B illustrates the cross-sectional view A-A′ of DOE wheel array 400.

It should be understood by those familiar with DOEs as beam splitters that DOEs are translationally invariant and not rotationally invariant. These characteristics of DOEs indicate that the arrangements in FIG. 2 or FIG. 3 (DOE linear array 140 or DOE rectangular array 300) are preferable to DOE wheel array 400. This is in direct contradiction to the teaching of U.S. Pat. No. 6,452,132 “Laser Hole Boring Apparatus”. In the embodiment shown in the 132 patent, the problem of the DOE wheel is exacerbated by the use of circular mounting holes and no measures are advised for dealing with this problem. The rectangular array 140 or square array 150 embodiments tolerate DOEs that are slightly misaligned with each other on subassembly 100 without causing any manufacturing defects when subassembly 100 is employed. But if DOE wheel array 400 is used as an alternate embodiment then due diligence must be adhered to, because DOEs do not allow for any misalignment rotationally.

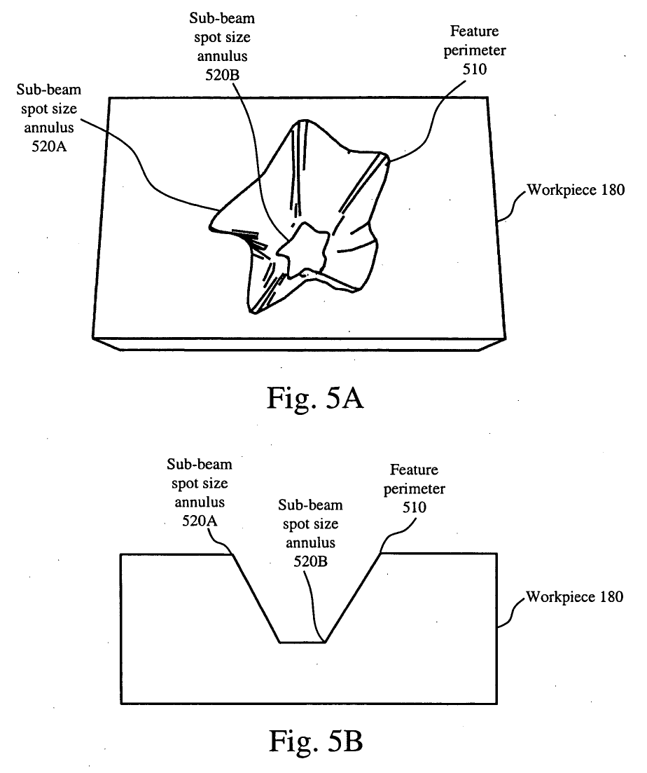

FIG. 5 illustrates a functional block diagram method 500 of operating subassembly 100 for drilling holes or vias of various sizes and shapes and multiple ablation or material transformation patterns in a surface of an object and includes the steps of:

Step 510: Determining product's number of patterns/layers specification

In this step, the number of patterns and the number of layers to pattern according to the product specifications is determined. Also, the sequence of patterns to be laid on the workpiece or sequence of layers to be processed is determined in this step. Method 500 proceeds to step 520.

Step 520: Designing and manufacturing multiple DOEs to match product specification

In this step, DOEs are designed to match product specifications defined in step 510. For example, designing and manufacturing is done using known methods of DOE fabrication. Each new pattern requires a separate DOE to be designed and manufactured. Method 500 proceeds to step 530.

Step 530: Assembling DOE array

In this step, the DOEs are assembled into an array of DOEs, for example, DOE linear array 140, DOE rectangular array 300, or DOE wheel array 400. The support for each of DOE linear array 140,. DOE rectangular array 300, or DOE wheel array 400 may be made of a glass substrate, or structured as a mechanical mount that allows DOEs to be accurately placed on the substrate. Each DOE is indexed by its position in the DOE array. While not required, it is desirable to have the DOE array index correspond to the pattern or layer sequence determined in Step 510. Method 500 proceeds to step 540.

Step 540: Processing pattern

In this step, the pattern on workpiece 170 is created, for example with a milling algorithm (not shown) employed by a laser processing system, which includes subassembly 100.

For example, greater hole density on one layer may be achieved by patterning with DOE 130a and then DOE 130b (after steps 560 and 570) and so forth if desired. Thus, a streamlined, non-complex, parallel laser processing system able to drill denser holes than conventional means is achieved.

Method 500 proceeds to step 550.

Step 550: More patterns on layer?

In this decision step, it is determined if the layer just ablated or transformed in step 540 needs additional patterns to be processed. If yes, then method 500 proceeds to step 570. If no, then method 500 proceeds to step 560.

Step 560: Next layer?

In this decision step, it is determined if there are more layers to be patterned on workpiece 170. If yes, then method 500 proceeds to step 570. If no, then method 500 ends.

Step 570: Changing and aligning DOE

In this step, the next DOE 130 is sequenced for use on subassembly 100 from the DOE linear array 140 or optionally DOE rectangular array 300 or optionally DOE wheel array 400. For example, DOE 130b would be used after DOE 130a. A simple changing and aligning mechanism is employed with stops, for example, a gas-driven actuator with fixed index points. Due diligence must be adhered to such that no rotational misalignment occurs in between each DOE change and alignment since DOEs are translationally invariant and not rotationally invariant. DOE linear array 140 and DOE square array 300 are the preferred embodiments, but DOE wheel array 400 may be used as alternate embodiments in subassembly 100.

The ability to change DOE 130 from one pattern to another streamlines the laser drilling process and allows for increased speed and throughput in a manufacturing process.

Method 500 proceeds to step 540 for further processing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A laser processing system for drilling holes or vias of various sizes and shapes and/or multiple ablation or material transformation patterns in a surface of an object, the system comprising:
a beam;
a plurality of DOEs;
a DOE array holder;
a scan lens;
a workpiece.

2. The system of claim 1, wherein some or all of the DOEs are capable of creating a plurality of sub-beams;

3. The system of claim 1, wherein said beam is emitted by a pulsed or continuous wave (CW) laser exhibiting a sufficiently small bandwidth to avoid chromatic aberrations induced by DOEs held by said DOE array holder, and providing sufficient pulse energy or average power to ablate or transform material in said workpiece.

4. The system of claim 1, wherein said DOE array holder holds an array of DOEs, said DOES acting as beam shapers or splitters to allow a laser processing system to drill parallel holes or vias of various sizes and shapes and multiple ablation or material transformation patterns on a material of said workpiece.

5. The system of claim 1, wherein said DOE array holder holds a plurality of DOEs and is used to index the DOEs in steps, one DOE per step.

6. The system of claim 1, wherein said shaped beams are formed by a DOE held by said DOE array holder from said beam after being transmitted through said DOE.

7. The system of claim 1, wherein said sub-beams are formed by a DOE held by said DOE array holder from said beam after being transmitted through said DOE.

8. The system of claim 1, wherein said scan lens is an f-theta telecentric (scan) lens determining spot size of said sub-beams upon said workpiece.

9. The system of claim 1, wherein said workpiece is a stainless steel inkjet nozzle foil.

10. The system of claim 1, wherein alternate holes, vias or patterns may be ablated or transformed with different DOEs on the DOE array.

11. The system of claim 1, wherein said DOE array holder is operable hold a linear array, and to linearly index DOEs of the array in a single linear dimension.

12. The system of claim 1, wherein said DOE array holder is operable to hold a rectangular array, and to linearly index DOEs of the array in two linear dimensions.

13. The system of claim 1, wherein said DOE array holder is operable to hold a wheel array, and to rotationally index DOEs of the array in at least one non-linear dimension.

14. The system of claim 13, wherein said DOE array holder and the wheel array are precisely aligned to take account of rotational variance of the DOEs.

15. A method of operation for use with a laser processing system for drilling holes or vias of various sizes and shapes and multiple ablation or material transformation patterns in a surface of an object, comprising:
determining a product's number of patterns and a number of layers to pattern according to product specifications;
designing multiple DOEs to match the product specifications;
assembling a DOE array of the multiple DOEs; and
processing multiple patterns on a workpiece using different DOEs of the array.

16. The method of claim 15, wherein determining the product's number of patterns and number of layers to pattern includes determining a sequence of patterns to be laid on the workpiece.

17. The method of claim 15, wherein determining the product's number of patterns and number of layers to pattern includes determining a sequence of layers to be processed.

18. The method of claim 15, wherein designing multiple DOEs includes manufacturing a designed DOE.

19. The method of claim 15, wherein designing multiple DOEs includes designing a separate DOE for each new pattern.

20. The method of claim 15, wherein assembling a DOE array of the multiple DOEs includes assembling in a linear array.

21. The method of claim 15, wherein assembling a DOE array of the multiple DOEs includes assembling in a rectangular array.

22. The method of claim 15, wherein assembling a DOE array of the multiple DOEs includes assembling in a wheel array.

23. The method of claim 15, wherein assembling a DOE array of the multiple DOEs includes indexing each DOE by its position in the DOE array.

24. The method of claim 15, wherein assembling a DOE array of the multiple DOEs includes establishing a correspondence between a DOE array index and a pattern or layer sequence.

25. The method of claim 15, wherein processing multiple patterns on the workpiece includes patterning with a first DOE and then a second DOE according to a pattern sequence.

26. The method of claim 15, further comprising determining whether more patterns need to be processed on a current layer.

27. The method of claim 15, further comprising determining whether more layers need to be patterned.

28. The method of claim 15, further comprising changing and aligning a DOE between sequential processing of the multiple patterns.

29. The method of claim 28, wherein changing and aligning a DOE includes sequencing a next DOE of the array.

30. The method of claim 28, wherein changing and aligning a DOE includes linearly translating the DOE in a linear dimension, absent rotational translation.

31. The method of claim 28, wherein changing and aligning a DOE includes linearly translating the DOE in at least two linear dimensions, absent rotational translation.

32. The method of claim 28, wherein changing and aligning a DOE includes rotationally translating the DOE in at least one nonlinear dimension, wherein a DOE array holder and a wheel array including the DOE are precisely aligned to take account of rotational variance of DOEs.
